(19) United States
(12) Patent Application Publication
(10) Pub. No.: US 2026/0299323 A1
(43) Pub. Date: Oct. 1, 2026

(54) OPTICAL MODULATOR, OPTICAL TRANSMITTER, AND METHOD FOR CONTROLLING OPERATING POINT OF OPTICAL MODULATOR

(71) Applicant: NEC Corporation, Tokyo (JP)

(72) Inventor: Kimiyoshi FUKATSU, Tokyo (JP)

(73) Assignee: NEC Corporation, Tokyo (JP)

(21) Appl. No.: 19/441,922

(22) Filed: Jan. 7, 2026

(30) Foreign Application Priority Data
Mar. 25, 2025 (JP) 2025-050243

(51) Int. Cl. G02F 1/01

(52) U.S. Cl. CPC G02F 1/0121; G02F 1/011

(57) ABSTRACT

In a ring resonator, input light is input to an input port. A heater is driven by a drive signal to control the temperature of the ring resonator. A modulation unit modulates the input light propagating through the ring resonator according to an applied modulation signal. A first light detection unit detects first light output from a drop port of the ring resonator and outputs a first detection signal indicating a detection result. A second light detection unit detects second light output from a through port of the ring resonator and outputs a second detection signal indicating a detection result. An intensity ratio, which is a ratio of the intensity of the first light to the intensity of the second light, is monitored. The operating point of the ring resonator is controlled by giving a drive signal based on the intensity ratio monitoring result to the heater.

### INCORPORATION BY REFERENCE

This application is based upon and claims the benefit of priority from Japanese patent application No. 2025-50243, filed on Mar. 25, 2025, the disclosure of which is incorporated herein in its entirety by reference.

### TECHNICAL FIELD

The present disclosure relates to an optical modulator, an optical transmitter, and a method for controlling an operating point of the optical modulator.

### BACKGROUND ART

In an optical transmitter of an optical transceiver used in an optical network, for example, as proposed in JP 2022-61930 A, use of an optical modulator configured using a ring resonator has progressed. In an optical modulator using a ring resonator, an operating point is controlled by adjusting an effective refractive index of the ring resonator by heating by a heater. An optical modulator using a ring resonator is smaller than a Mach-Zehnder type optical modulator and can cope with a wide band.

### SUMMARY

In the optical modulator using the ring resonator, since the operating point depends on the wavelength of light, the operating point varies due to a variation in the wavelength of light output from a semiconductor laser to be modulated due to a change in the environmental temperature. The operating point also varies in a case where the effective refractive index of the ring-shaped optical waveguide itself varies depending on the environmental temperature. Therefore, it is required to appropriately adjust the operating point of the optical modulator so as not to be affected by the fluctuation of the operating point.

In an optical modulator using a ring resonator, an operating point is generally searched for by monitoring the intensity of light output from a through port that is a drop port or an output port of the ring resonator. However, in this case, it is necessary to monitor the intensity of light for each wavelength while sweeping the wavelength of light input to the ring resonator at least in a range of one span of a free spectral range (FSR). Therefore, there is a problem that it is difficult to speed up the search for the operating point.

An optical modulator according to one example aspect of the present disclosure includes a ring resonator in which input light is input to an input port, a heater that is driven by a drive signal to control a temperature of the ring resonator, a modulation means for modulating the input light propagating through the ring resonator according to an applied modulation signal, the modulation means being provided in the ring resonator, a first light detection means for detecting first light output from a drop port of the ring resonator and outputting a first detection signal indicating a detection result, and a second light detection means for detecting second light output from a through port of the ring resonator and outputting a second detection signal indicating a detection result, in which an intensity ratio that is a ratio of an intensity of the first light to an intensity of the second light is monitored based on the first and second detection signals, and an operating point of the ring resonator is controlled by applying the drive signal based on a monitoring result of the intensity ratio to the heater.

In a method for controlling an operating point of an optical modulator according to one example aspect of the present disclosure, the optical modulator includes a ring resonator in which input light is input to an input port, a heater that is driven by a drive signal to control a temperature of the ring resonator, a modulation means for modulating the input light propagating through the ring resonator according to an applied modulation signal, the modulation means being provided in the ring resonator, a first light detection means for detecting first light output from a drop port of the ring resonator and outputting a first detection signal indicating a detection result, and a second light detection means for detecting second light output from a through port of the ring resonator and outputting a second detection signal indicating a detection result. The method includes monitoring an intensity ratio that is a ratio of an intensity of the first light to an intensity of the second light based on the first and second detection signals, and controlling an operating point of the ring resonator by applying the drive signal based on a monitoring result of the intensity ratio to the heater.

According to the present disclosure, it is possible to provide an optical modulator, an optical transmitter, and a method for controlling an operating point of the optical modulator capable of efficiently controlling the operating point of the optical modulator with a simple configuration.

### BRIEF DESCRIPTION OF THE DRAWINGS

FIG. 1 is a diagram schematically illustrating a configuration of an optical transmitter according to one example embodiment;

FIG. 2 is a diagram schematically illustrating a configuration of an optical modulator according to one example embodiment;

FIG. 3 is a diagram illustrating intensities of transmission light and drop light from a through port;

FIG. 4 is a diagram schematically illustrating a configuration of a control unit according to one example embodiment;

FIG. 5 is a diagram illustrating operating point control of the optical modulator;

FIG. 6 is a flowchart of an operating point control operation of the optical modulator according to one example embodiment;

FIG. 7 is a diagram schematically illustrating a configuration of an optical transmitter according to one example embodiment; and

FIG. 8 is a diagram schematically illustrating a configuration of an optical transmitter according to one example embodiment.

### EXAMPLE EMBODIMENT

Hereinafter, example embodiments of the present invention will be described with reference to the drawings. In the drawings, the same elements are denoted by the same reference signs, and redundant description will be omitted as necessary.

Hereinafter, the term “one example embodiment” means that it is applicable to any of the example embodiments described below or a combination of two or more example embodiments, and the application is not limited to a specific example embodiment.

### First Example Embodiment

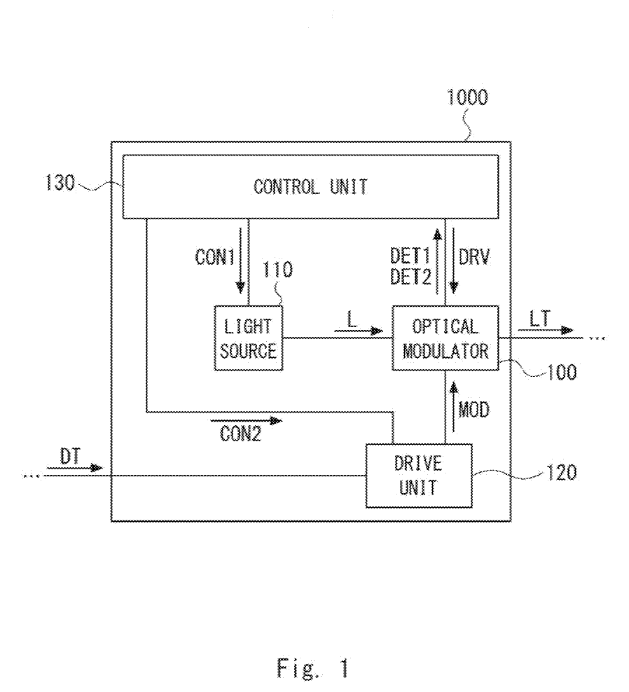

An optical modulator according to one example embodiment and an optical transmitter on which the optical modulator is mounted will be described. FIG. 1 is a diagram schematically illustrating a configuration of an optical transmitter according to one example embodiment. An optical transmitter 1000 includes an optical modulator 100, a light source 110, a drive unit 120, and a control unit 130.

The light source 110 is configured as, for example, a semiconductor laser such as a distributed feedback (DFB) laser. The light source 110 outputs laser light having a predetermined wavelength to the optical modulator 100 as input light L. As will be described later, the light source 110 performs auto power control (APC) of the operating current so that an optical modulation amplitude (OMA) output of the optical modulator 100 becomes constant.

The drive unit 120 outputs a modulation signal MOD to the optical modulator 100 according to a transmission data signal DT input from a host device such as an external optical transmission device. A bias component for controlling the operating point of the optical modulator 100 and a modulation component relevant to the transmission data signal DT are superimposed on the modulation signal MOD. The optical modulator 100 controls pre-emphasis and amplitude of the modulation signal according to a control signal CON2 input from the control unit 130.

The control unit 130 controls the current applied to the semiconductor laser constituting the light source 110 such that the OMA output of the optical modulator 100 becomes constant by a control signal CON1. The control unit 130 also has a function of controlling the operation of the drive unit 120 by the control signal CON2. In order to control the operating point of the optical modulator 100, the control unit 130 outputs a drive signal DRV to a micro-heater for adjusting the temperature of the ring resonator provided in the optical modulator 100 as described later.

The optical modulator 100 outputs transmission light LT obtained by modulating the input light L according to the modulation signal MOD. As will be described later, the optical modulator 100 outputs a detection signal DET1 indicating a detection result of light output from the drop port of the ring resonator and a detection signal DET2 indicating a detection result output from the through port to the control unit 130. The control unit 130 detects an operating point of the optical modulator 100 based on the detection signals DET1 and DET2.

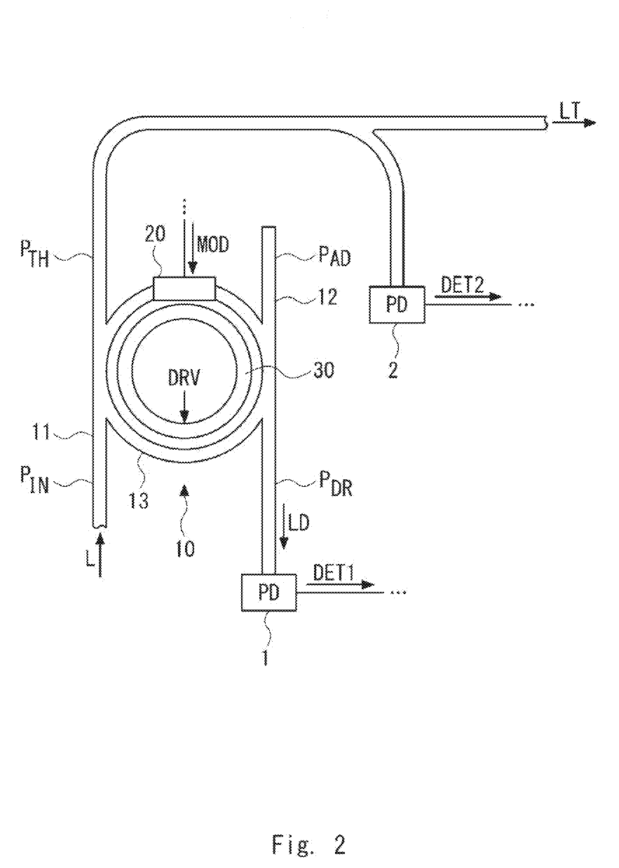

Next, an optical modulator 100 according to a first example embodiment will be described. FIG. 2 is a diagram schematically illustrating a configuration of an optical modulator according to one example embodiment. The optical modulator 100 includes a ring resonator 10, an electrode 20, a micro-heater 30, and optical detectors (PD) 1 and 2.

The ring resonator 10 has a configuration in which a ring-shaped optical waveguide 13 is connected between two linear optical waveguides 11 and 12. The connection portion between the linear optical waveguide 11 and the ring-shaped optical waveguide 13 and the connection portion between the linear optical waveguide 12 and the ring-shaped optical waveguide 13 are provided at positions facing each other across the center of the ring-shaped optical waveguide 13. One end of the linear optical waveguide 11 is an input port P_{IN} of the ring resonator 10, and the other end is a through port P_{TH}. One end of the linear optical waveguide 12 is an add port P_{AD} of the ring resonator 10, and the other end is a drop port P_{DR}. In the ring resonator 10, the input light L is input to the input port P_{IN}, and the light output from the through port P_{TH} is output as the transmission light LT. The drop light LD is output from the drop port P_{DR} of the ring resonator 10.

The electrode 20 is provided on the ring-shaped optical waveguide 13. The modulation signal MOD is applied from the drive unit 120 to the electrode 20. As a result, the effective refractive index of the ring-shaped optical waveguide 13 is changed to phase-modulate the input light L propagating through the ring-shaped optical waveguide 13.

The micro-heater 30 is a ring-shaped heater provided along ring-shaped optical waveguide 13. The drive signal DRV is applied from the control unit 130 to the micro-heater 30. As a result, the operating point of the optical modulator 100 can be adjusted by controlling the effective refractive index by adjusting the temperature of the ring-shaped optical waveguide 13 by the heat generation of the micro-heater 30.

The optical detector 1 is connected to the drop port P_{DR} of the ring resonator 10. As a result, the optical detector 1 detects the drop light LD output from the drop port P_{DR} of the ring resonator 10. The optical detector 1 outputs the detection signal DET1 indicating a detection result of the drop light LD to the control unit 130.

A part of the transmission light LT output from the through port P_{TH} of the ring resonator 10 is branched and enters the optical detector 2. As a result, the optical detector 2 detects the transmission light LT that can be converted from the branching ratio. The optical detector 2 outputs the detection signal DET2 indicating a detection result of the transmission light LT to the control unit 130.

The optical detectors 1 and 2 may be, for example, various photodiodes or various light detection means of parts including photodiodes. Here, the optical detectors 1 and 2 include photodiodes, and output the detection signals DET1 and DET2 as current signals. The optical detectors 1 and 2 are also referred to as first and second optical detectors.

Next, detection of an operating point of the ring resonator 10 by the control unit 130 will be described. The control unit 130 monitors the intensities of the transmission light LT and the drop light LD based on the detection signals DET1 and DET2. Then, the control unit 130 detects the operating point of the ring resonator 10 based on an intensity ratio R_{L} = I[LD]/I[LT], which is a ratio of the intensity I[LD] of the drop light LD to the intensity I[LT] of the transmission light LT.

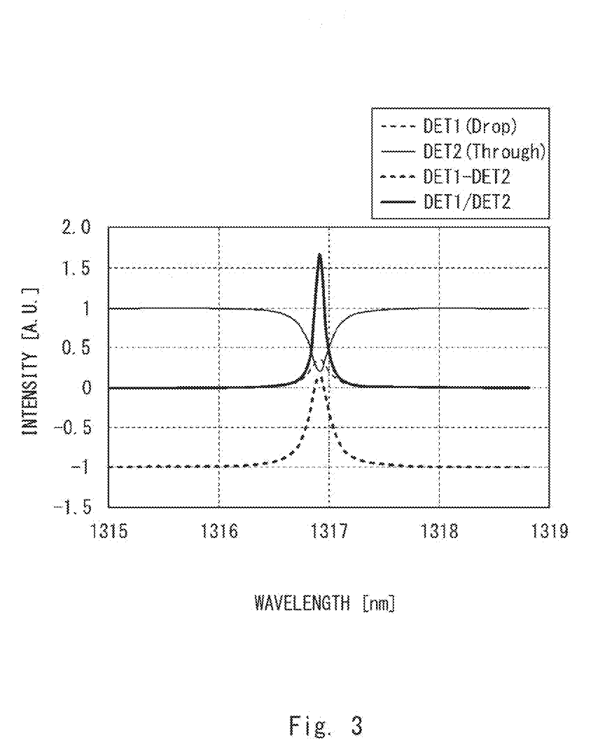

FIG. 3 is a diagram illustrating intensities of transmission light and drop light from a through port. The drop light LD has a spectrum having a peak near the resonance wavelength of the ring resonator 10. On the other hand, the transmission light LT output from the through port P_{TH} has a spectrum having a valley (so-called trough) in the vicinity of the resonance wavelength of the ring resonator 10.

In FIG. 3, DET1-DET2 indicating I[LD]-I[LT] and DET1/DET2 indicating I[LD]/I[LT] are displayed for reference. As described above, a peak steeper than the peak of the drop light LD and the valley of the transmission light LT appears in DET1/DET2 indicating I[LD]/I[LT]. The peak of DET1/DET2 is steeper than that of DET1-DET2. Therefore, the control unit 130 can detect the operating point of the ring resonator 10 by observing DET1/DET2 indicating I[LD]/I[LT].

Therefore, by monitoring the intensity ratio R_{L} = I[LD]/I[LT], the control unit 130 can easily detect the resonance wavelength of the ring resonator 10, that is, the operating point of the optical modulator 100. As a result, the operating point of the ring resonator 10 can be detected with higher accuracy as compared with a case where the peak of the drop light LD or the valley of the transmission light LT is monitored as in a general method.

Since a narrow and strong peak appears only once on the monitor of the intensity ratio R_{L} = I[LD]/I[LT] during the sweep of the FSR for one span, it is possible to easily detect the peak by appropriately setting the threshold. This enables high-speed and accurate operating point detection.

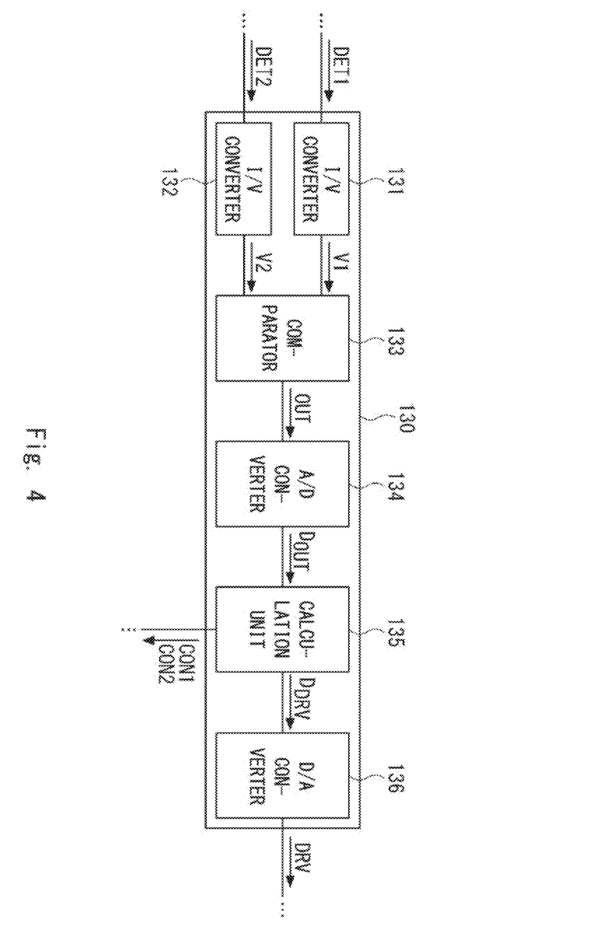

A configuration of the control unit 130 that realizes the above operating point detection will be described. FIG. 4 is a diagram schematically illustrating a configuration of a control unit according to one example embodiment. The control unit 130 includes current-voltage converters (hereinafter, I/V converter) 131 and 132, a comparator 133, an analog-digital converter (hereinafter, A/D converter) 134, a calculation unit 135, and a digital-analog converter (hereinafter, D/A converter) 136.

The I/V converter 131 converts the detection signal DET1, which is a current signal output from the optical detector 1, into a voltage signal V1. The I/V converter 132 converts the detection signal DET2, which is a current signal output from the optical detector 2, into a voltage signal V2. The comparator 133 outputs an output signal OUT which is an analog signal indicating a comparison result between the voltage signal V1 and the voltage signal V2. The A/D converter 134 converts the output signal OUT from the comparator 133 into a digital output signal D_{OUT}.

The calculation unit 135 is configured to be able to output the control signals CON1 and CON2 to the light source 110 and the drive unit 120 as appropriate. The calculation unit 135 detects the operating point of the optical modulator 100 based on the digital output signal D_{OUT}.

In the present configuration, the comparator 133 may be configured to transition the output signal OUT in a case where the ratio of the voltage signal V1 to the voltage signal V2, that is, the intensity ratio R_{L} becomes larger than a predetermined value. Accordingly, the calculation unit 135 can easily detect the operating point of the optical modulator 100 by detecting that intensity ratio R_{L} becomes larger than a predetermined value.

The calculation unit 135 outputs a digital drive signal D_{DRV} to the D/A converter 136 according to the detection result of the operating point of the optical modulator 100. The D/A converter 136 converts the digital drive signal D_{DRV} into the drive signal DRV that is an analog signal. Then, the D/A converter 136 outputs the drive signal DRV to the micro-heater 30.

As described above, the control unit 130 can provide the micro-heater 30 with the drive signal DRV suitable for setting the operating point of the ring resonator 10 to a desired operating point according to the search result of the operating point of the ring resonator 10.

Also in a general method, it is conceivable to provide the optical detectors 1 and 2 as in the optical modulator 100 according to the present example embodiment and individually monitor both the transmission light LT and the drop light LD. However, in this case, the control unit needs to be provided with an I/V converter and an A/D converter relevant to the detection signal DET1, and an I/V converter and an A/D converter relevant to the detection signal DET2. Therefore, the number of A/D converters having a circuit scale larger than that of the control unit 130 according to the present example embodiment is increased by one, which leads to an increase in the footprint of the control unit. On the other hand, in the control unit 130, since the number of A/D converters can be reduced to one, the size can be reduced. Therefore, the control unit 130 is advantageous in realizing miniaturization of the optical transmitter 1000.

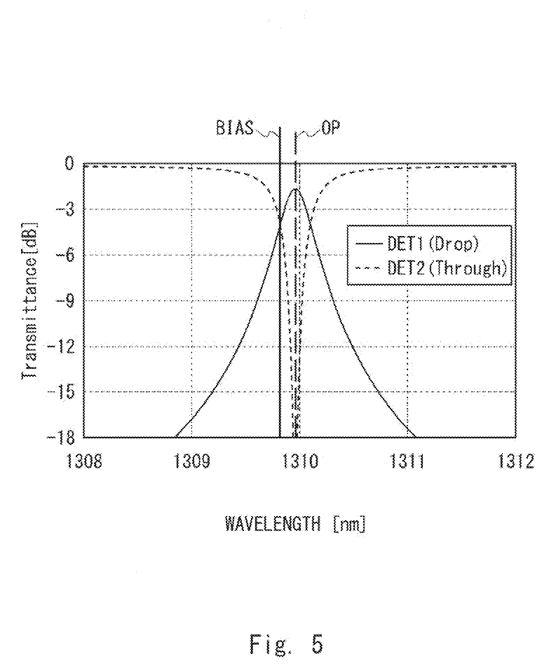

Next, the operating point control of the optical modulator 100 will be described. FIG. 5 is a diagram illustrating operating point control of the optical modulator. Here, a searched operating point OP of the optical modulator 100 is displayed. The operating point of the optical modulator 100 is adjusted only by controlling the micro-heater 30 so that the operating point is optimized while a constant bias voltage is applied. Since the resonance point is shifted by the amplitude of the modulated voltage signal to the electrode 20, the intensity of the transmission light LT can be changed.

In the optical modulator 100, in order to realize high-speed modulation, an operating point is desirably set in a slope portion where intensity change is steep in a spectrum.

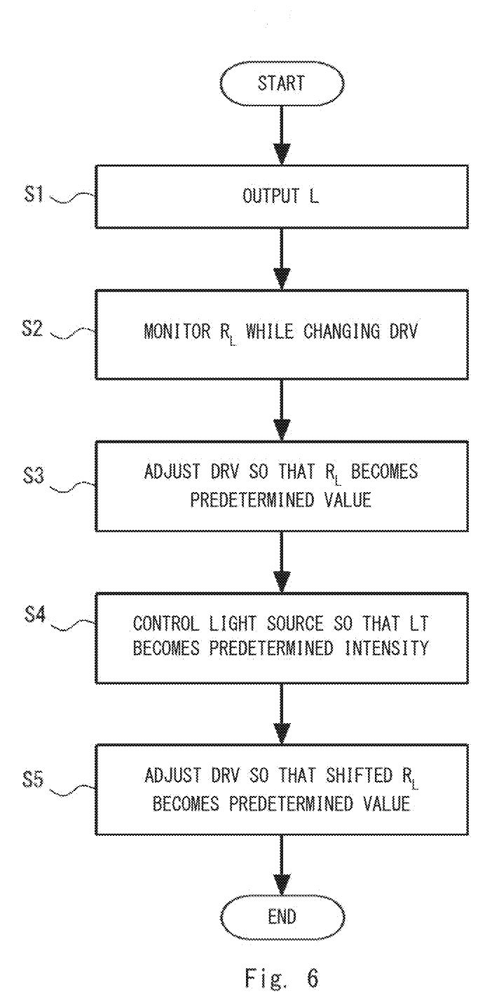

Next, a flow of the operating point control operation in the optical modulator 100 will be described. FIG. 6 is a flowchart of an operating point control operation of the optical modulator according to one example embodiment.

### Step S1

A constant current is applied to the semiconductor laser constituting the light source 110. Thus, the light source 110 outputs the input light L to the optical modulator 100.

### Step S2

The intensity ratio R_{L} is monitored while the voltage of the drive signal DRV applied to the micro-heater 30 is circulated in a range relevant to 1FSR.

### Step S3

The control unit 130 controls the micro-heater 30 by adjusting the voltage of the drive signal DRV so that the intensity ratio R_{L} becomes a predetermined value. At this time, for example, the micro-heater 30 may be controlled so that the intensity ratio R_{L} falls within a predetermined range including a predetermined value.

### Step S4

The current value of the semiconductor laser constituting the light source 110 is adjusted so that the light output of the transmission light LT has a desired intensity.

### Step S5

Since the operating point of the ring resonator 10 is shifted by the intensity of the input light L input to the ring resonator 10, the micro-heater 30 is further finely adjusted so that the intensity ratio R_{L} becomes a predetermined value.

As described above, according to this configuration, it is possible to search for the operating point of the optical modulator at high speed and with high accuracy with a simple configuration in which two optical detectors are provided in the optical modulator. As a result, the operating point control of the optical modulator according to the search result can be efficiently realized with a simple configuration.

Therefore, by performing control such that the intensity ratio R_{L} is always constant during operation of the optical transmitter in actual data communication, optical communication can be maintained at a desired quality.

### Second Example Embodiment

Although the one-channel optical transmitter has been described in the first example embodiment, it is possible to configure an optical transmitter capable of outputting multi-channel optical signals by combining one light source and a plurality of optical modulators according to the above-described example embodiments. A specific example thereof will be described below.

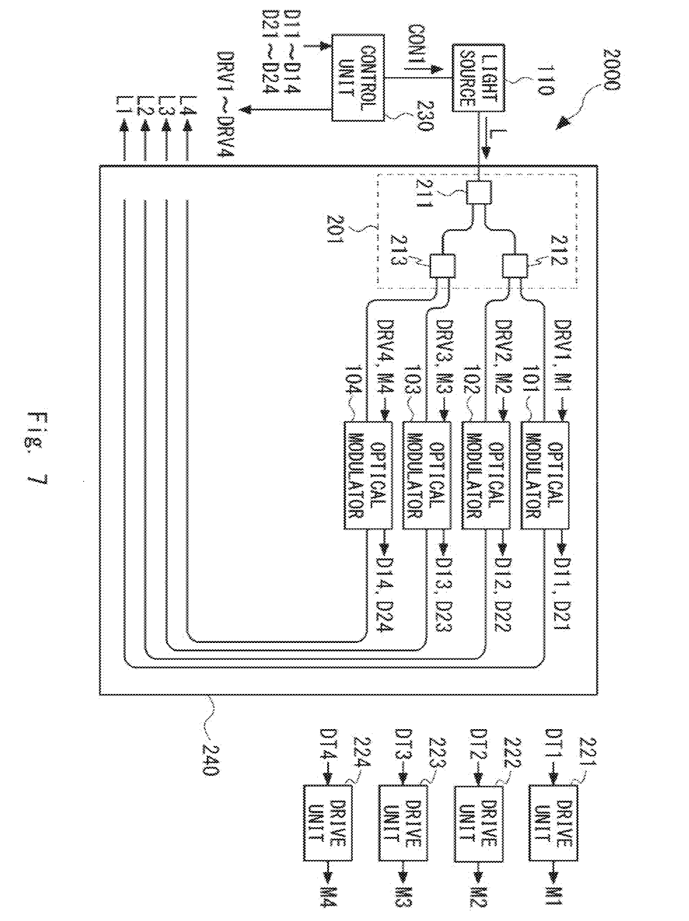

FIG. 7 is a diagram schematically illustrating a configuration of an optical transmitter according to one example embodiment. An optical transmitter 2000 illustrated in FIG. 7 is an optical transmitter that transmits optical signals of four channels. The optical transmitter 2000 includes optical modulators 101 to 104 having a configuration similar to that of the optical modulator 100 according to the first example embodiment, a light source 110, an optical distribution unit 201, drive units 221 to 224, and a control unit 230.

The optical modulators 101 to 104 and the optical distribution unit 201 may be configured as, for example, an optical element chip 240 which is a Si photonics element formed on the same substrate.

The light source 110 outputs the input light L to the optical distribution unit 201. The optical distribution unit 201 branches the input light L from the light source 110 into four toward the optical modulators 101 to 104.

The optical distribution unit 201 includes optical branch units 211 to 213 each having one input and two outputs. The optical branch units 211 to 213 may be configured as various optical components that branch light into two, such as an optical coupler and a Y-branch.

The optical branch unit 211 branches the input light L output from the light source 110 into the optical branch unit 212 and the optical branch unit 213. The optical branch unit 212 branches the input light L branched by the optical branch unit 211 into the optical modulator 101 and the optical modulator 102. The optical branch unit 213 branches the input light L branched by the optical branch unit 211 into the optical modulator 103 and the optical modulator 104.

The drive units 221 to 224 output modulation signals M1 to M4 relevant to four transmission data signals DT1 to DT4 of different channels to the optical modulators 101 to 104. The transmission data signals DT1 to DT4 are relevant to the transmission data signal DT input to the drive unit 120 of the optical modulator 100 according to the first example embodiment. The modulation signals M1 to M4 are relevant to the modulation signal MOD output from the drive unit 120.

Similarly to the optical modulator 100, the optical modulators 101 to 104 modulate the input light L based on the modulation signals M1 to M4, and output the transmission light LT1 to LT4. As a result, the optical modulators 101 to 104 can transmit an optical signal obtained by modulating the input light similarly to the optical modulator 100 according to the first example embodiment.

The optical detectors 1 of the optical modulators 101 to 104 output detection signals D11 to D14 relevant to the detection signal DET1 output from the optical detector 1 of the optical modulator 100 to the control unit 230. The optical detectors 2 of the optical modulators 101 to 104 output detection signals D21 to D24 relevant to the detection signal DET2 output from the optical detector 2 of the optical modulator 100 to the control unit 230.

The control unit 230 outputs drive signals DRV1 to DRV4 relevant to the drive signal DRV output from the control unit 130 to the micro-heaters 30 of the optical modulators 101 to 104. As a result, in the optical transmitter 2000, the operating points of the optical modulators 101 to 104 can be controlled similarly to the control of the operating point of the optical modulator 100 according to the first example embodiment.

The control unit 230 controls the drive units 221 to 224 by the control signal in the same manner as the control unit 130 controlling the drive unit 120 by the control signal CON2. For simplification of the drawing, illustration of control signals provided from the control unit 230 to the drive units 221 to 224 is omitted.

According to this configuration, it is possible to configure the optical transmitter 2000 that is provided with the four optical modulators capable of easily adjusting the operating point with respect to one light source and is capable of transmitting four-channel optical signals. As described above, since the optical modulators 101 to 104 can have a simple configuration, it is advantageous from the viewpoint of downsizing the optical transmitter 2000.

Next, another example of the optical transmitter will be described. Although the four-channel optical transmitter 2000 has been described above, the number of channels can be changed as necessary.

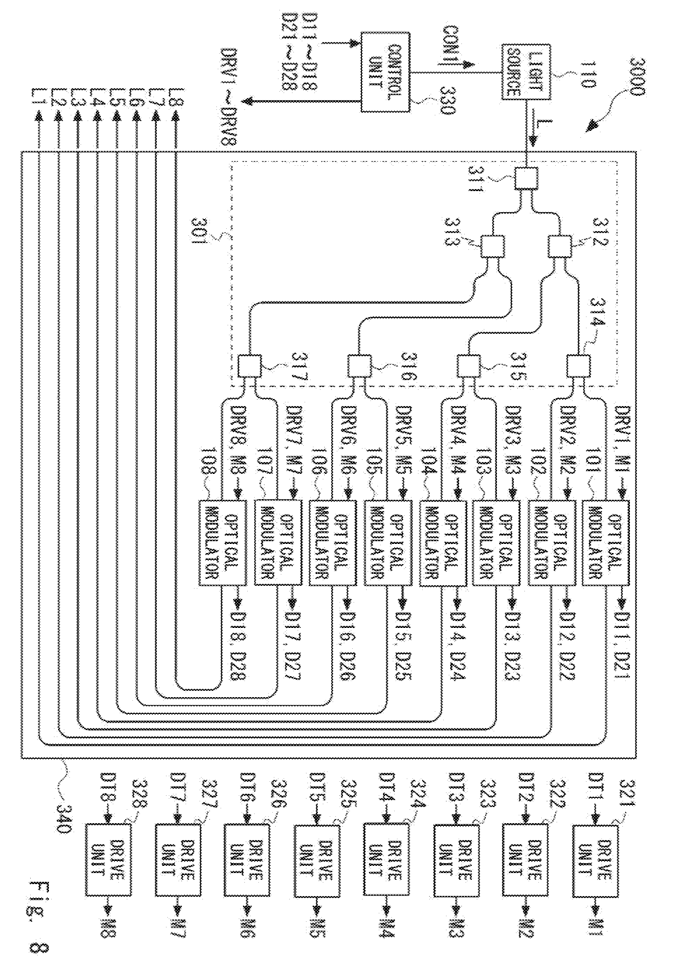

FIG. 8 is a diagram schematically illustrating a configuration of an optical transmitter according to one example embodiment. An optical transmitter 3000 illustrated in FIG. 8 is an optical transmitter that transmits optical signals of eight channels. The optical transmitter 3000 includes optical modulators 101 to 108 having a configuration similar to that of the optical modulator 100 according to the first example embodiment, a light source 110, an optical distribution unit 301, drive units 321 to 328, and a control unit 330.

The optical modulators 101 to 108 and the optical distribution unit 301 may be configured as, for example, an optical element chip 340 which is a Si photonics element formed on the same substrate.

The light source 110 outputs the input light L to the optical distribution unit 301. The optical distribution unit 301 branches the input light L from the light source 110 into eight toward the optical modulators 101 to 108.

The optical distribution unit 301 includes optical branch units 311 to 317 each having one input and two outputs. The optical branch units 311 to 317 may be configured as various optical components that branch light into two, such as an optical coupler and a Y-branch.

The optical branch unit 311 branches the input light L output from the light source 110 into the optical branch unit 312 and the optical branch unit 313. The optical branch unit 312 branches the input light L branched by the optical branch unit 311 into an optical branch unit 314 and an optical branch unit 315. The optical branch unit 313 branches the input light L branched by the optical branch unit 311 into an optical branch unit 316 and an optical branch unit 317.

The optical branch unit 314 branches the input light L branched by the optical branch unit 312 into the optical modulator 101 and the optical modulator 102. The optical branch unit 315 branches the input light L branched by the optical branch unit 312 into the optical modulator 103 and the optical modulator 104. The optical branch unit 316 branches the input light L branched by the optical branch unit 313 into the optical modulator 105 and the optical modulator 106. The optical branch unit 317 branches the input light L branched by the optical branch unit 313 into the optical modulator 107 and the optical modulator 108.

The drive units 321 to 328 output modulation signals M1 to M8 relevant to eight transmission data signals DT1 to DT8 of different channels to the optical modulators 101 to 108. The transmission data signals DT1 to DT8 are relevant to the transmission data signal DT input to the drive unit 120 of the optical modulator 100 according to the first example embodiment. The modulation signals M1 to M8 are relevant to the modulation signal MOD output from the drive unit 120.

Similarly to the optical modulator 100, the optical modulators 101 to 108 modulate the input light L based on the modulation signals M1 to M4, and output the transmission light LT1 to LT8. As a result, the optical modulators 101 to 108 can transmit an optical signal obtained by modulating the input light similarly to the optical modulator 100 according to the first example embodiment.

The optical detectors 1 of the optical modulators 101 to 108 output detection signals D11 to D18 relevant to the detection signal DET1 output from the optical detector 1 of the optical modulator 100 to the control unit 330. The optical detectors 2 of the optical modulators 101 to 108 output detection signals D21 to D28 relevant to the detection signal DET2 output from the optical detector 2 of the optical modulator 100 to the control unit 330.

The control unit 330 outputs drive signals DRV1 to DRV8 relevant to the drive signal DRV output from the control unit 130 to the micro-heaters 30 of the optical modulators 101 to 108. As a result, in the optical transmitter 3000, the operating points of the optical modulators 101 to 108 can be controlled similarly to the control of the operating point of the optical modulator 100 according to the first example embodiment.

The control unit 330 controls the drive units 321 to 328 by the control signal in the same manner as the control unit 130 controlling the drive unit 120 by the control signal CON2. For simplification of the drawing, illustration of control signals provided from the control unit 330 to the drive units 321 to 328 is omitted.

According to this configuration, it is possible to configure the optical transmitter 3000 that is provided with the eight optical modulators capable of easily adjusting the operating point with respect to one light source and is capable of transmitting eight-channel optical signals. As described above, since the optical modulators 101 to 108 can have a simple configuration, it is advantageous from the viewpoint of downsizing the optical transmitter 3000.

As can be seen from the configurations of the optical transmitters 2000 and 3000, the number of installed optical modulators can be increased and the number of channels can be easily increased by changing the number of branches of the input light L in the optical distribution unit. Therefore, according to the present configuration, it is possible to easily realize an optical transmitter capable of satisfying the required number of channels.

In the above description, an optical transmitter that transmits optical signals of four channels or eight channels has been described, but this is merely an example. The optical distribution unit may be configured to branch the input light L into any number of two or more. In this case, by providing optical modulators and drive units according to the number of light branches, an optical transmitter that can transmit optical signals of any number of two or more channels may be configured.

### Other Example Embodiments

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

In the above example embodiment, the example in which the electrode 20 is provided on a part of the ring-shaped optical waveguide 13 has been described, but this is merely an example. Any shape and number of electrodes may be provided at any position as long as desired modulation can be performed on light propagating through the ring-shaped optical waveguide.

Although the example in which the micro-heater 30 is a ring-shaped heater provided inside the ring-shaped optical waveguide 13 has been described, this is merely an example. Any shape and number of micro-heaters may be provided at any position as long as the ring-shaped optical waveguide can have a desired temperature.

Each drawing is merely illustrative for describing one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps described in any one of the drawings may be changed as appropriate.

Some or all of the example embodiments described above may also be described as, but are not limited to, the following Supplementary Notes.

### Supplementary Note 1

An optical modulator including:

a ring resonator in which input light is input to an input port;

a heater that is driven by a drive signal to control a temperature of the ring resonator;

a modulation means for modulating the input light propagating through the ring resonator according to an applied modulation signal, the modulation means being provided in the ring resonator;

a first light detection means for detecting first light output from a drop port of the ring resonator and outputting a first detection signal indicating a detection result; and

a second light detection means for detecting second light output from a through port of the ring resonator and outputting a second detection signal indicating a detection result, in which

an intensity ratio that is a ratio of an intensity of the first light to an intensity of the second light is monitored based on the first and second detection signals, and

an operating point of the ring resonator is controlled by applying the drive signal based on a monitoring result of the intensity ratio to the heater.

### Supplementary Note 2

The optical modulator according to Supplementary Note 1, in which an operating point of the ring resonator is controlled by applying the drive signal to the heater in such a way that the intensity ratio becomes a predetermined value.

### Supplementary Note 3

The optical modulator according to Supplementary Note 2, in which a change in the intensity ratio is monitored in a state where a wavelength of the input light fluctuates, and the drive signal is provided to the heater according to a fluctuation in a monitoring result of the intensity ratio due to a fluctuation in the wavelength of the input light in such a way that the operating point of the ring resonator is maintained at a predetermined operating point.

### Supplementary Note 4

An optical transmitter including:

the optical modulator according to any one of Supplementary Notes 1 to 3;

a light source that outputs the input light to the ring resonator;

a drive means for outputting the modulation signal to the modulation means; and

a control means for monitoring the intensity ratio based on the first and second detection signals and controlling the operating point of the ring resonator by giving the heater with the drive signal based on the monitoring result of the intensity ratio.

### Supplementary Note 5

An optical transmitter comprising:

a plurality of the optical modulators according to any one of Supplementary Notes 1 to 3;

a light source that outputs the input light to the ring resonator;

an optical distribution means for branching the input light into a plurality of pieces and distributing the plurality of pieces of the input light to the plurality of optical modulators;

a plurality of drive means for outputting a plurality of the modulation signals to modulation means of the plurality of optical modulators; and

a control means for controlling the operating point of the ring resonator of each of the plurality of optical modulators by monitoring a plurality of the intensity ratios of the plurality of optical modulators based on the first and second detection signals from the plurality of optical modulators and giving the plurality of drive signals based on monitoring results of the plurality of intensity ratios to heaters of the plurality of optical modulators.

### Supplementary Note 6

A method for controlling an operating point of an optical modulator, in which

the optical modulator includes a ring resonator in which input light is input to an input port, a heater that is driven by a drive signal to control a temperature of the ring resonator, a modulation means for modulating the input light propagating through the ring resonator according to an applied modulation signal, the modulation means being provided in the ring resonator, a first light detection means for detecting first light output from a drop port of the ring resonator and outputting a first detection signal indicating a detection result, and a second light detection means for detecting second light output from a through port of the ring resonator and outputting a second detection signal indicating a detection result, and

the method includes:

monitoring an intensity ratio that is a ratio of an intensity of the first light to an intensity of the second light based on the first and second detection signals; and

controlling an operating point of the ring resonator by applying the drive signal based on a monitoring result of the intensity ratio to the heater.

1. An optical modulator comprising:
a ring resonator in which input light is input to an input port;
a heater that is driven by a drive signal to control a temperature of the ring resonator;
a modulator that modulates the input light propagating through the ring resonator according to an applied modulation signal, the modulator being provided in the ring resonator;
a first light detector that detects first light output from a drop port of the ring resonator and outputs a first detection signal indicating a detection result; and
a second light detector that detects second light output from a through port of the ring resonator and outputs a second detection signal indicating a detection result, wherein
an intensity ratio that is a ratio of an intensity of the first light to an intensity of the second light is monitored based on the first and second detection signals, and
an operating point of the ring resonator is controlled by applying the drive signal based on a monitoring result of the intensity ratio to the heater.

2. The optical modulator according to claim 1, wherein an operating point of the ring resonator is controlled by applying the drive signal to the heater in such a way that the intensity ratio becomes a predetermined value.

3. The optical modulator according to claim 2, wherein a change in the intensity ratio is monitored in a state where a wavelength of the input light fluctuates, and the drive signal is provided to the heater according to a fluctuation in a monitoring result of the intensity ratio due to a fluctuation in the wavelength of the input light in such a way that the operating point of the ring resonator is maintained at a predetermined operating point.

4. An optical transmitter comprising:
the optical modulator according to claim 1;
a light source that outputs the input light to the ring resonator;
a driver that outputs the modulation signal to the modulator; and
a controller that monitors the intensity ratio based on the first and second detection signals and controls the operating point of the ring resonator by giving the heater with the drive signal based on the monitoring result of the intensity ratio.

5. An optical transmitter comprising:
a plurality of the optical modulators according to claim 1;
a light source that outputs the input light to the ring resonator;
an optical distributor that branches the input light into a plurality of pieces and distributes the plurality of pieces of the input light to the plurality of optical modulators;
a plurality of drivers that output a plurality of the modulation signals to the modulators of the plurality of optical modulators; and
a controller that controls the operating point of the ring resonator of each of the plurality of optical modulators by monitoring a plurality of the intensity ratios of the plurality of optical modulators based on the first and second detection signals from the plurality of optical modulators and gives the plurality of drive signals based on monitoring results of the plurality of intensity ratios to heaters of the plurality of optical modulators.

6. A method for controlling an operating point of an optical modulator, wherein
the optical modulator includes a ring resonator in which input light is input to an input port, a heater that is driven by a drive signal to control a temperature of the ring resonator, a modulator that modulates the input light propagating through the ring resonator according to an applied modulation signal, the modulator being provided in the ring resonator, a first light detector that detects first light output from a drop port of the ring resonator and outputs a first detection signal indicating a detection result, and a second light detector that detects second light output from a through port of the ring resonator and outputs a second detection signal indicating a detection result, and
the method comprises:
monitoring an intensity ratio that is a ratio of an intensity of the first light to an intensity of the second light based on the first and second detection signals; and
controlling an operating point of the ring resonator by applying the drive signal based on a monitoring result of the intensity ratio to the heater.
